(19) United States
(12) Patent Application Publication
(10) Pub. No.: US 2023/0240203 A1
(43) Pub. Date: Aug. 3, 2023

(54) INDETERMINATE PLANT SUPPORT STRUCTURE

(71) Applicant: Reuban Edward James Nataraj, Germantown, MD (US)

(72) Inventor: Reuban Edward James Nataraj, Germantown, MD (US)

(21) Appl. No.: 17/591,589

(22) Filed: Feb. 2, 2022

(51) Int. Cl. A01G 9/12; F16M 11/28

(52) U.S. Cl. CPC A01G 9/124; F16M 11/28

(57) ABSTRACT

An indeterminate plant support structure comprising a plant support structure base, vertical supports, angular supports and connectors, wherein vertical supports and angular supports are coupled by a connector to form a helical shape on multiple stages. Using a telescopic pole, thread feeder and thread, an indeterminate plant is grown vertically. When the plant reaches maximum height of the telescopic pole, then the plant stem is placed above the angular supports to form a helical shape by which the height of the plant is converted into circumference of a helical shape and load on the indeterminate plant and fruit is distributed to indeterminate plant support structure.

### BACKGROUND OF THE INVENTION

### Field of the Invention

The present invention is in the field of gardening and more particularly to plant support structures for indeterminate plant.

### Description of the Background Art

In gardening, load-acting supporting structures are used to provide additional support to an indeterminate plant as it grows indeterminately. Typically, a vertical structure is placed near a plant in the early stages of growth; as the plant matures, it's difficult to grow due to the height constraint as it grows vertically without any limits.

One common type of load-supporting structure for indeterminate plants is conventional stakes, which are vertical members with limitations in height. The stakes extend downward such that they can be securely inserted into the soil surrounding the plant, and the plant cannot be grown beyond the height of the stakes.

There are several disadvantages associated with conventional plant load-supporting structures (e.g., tomato stakes). For example, conventional plant load-supporting structures are relatively lengthy with limited height, and therefore, difficult to store and ship. As another example, they have to be staked into the soil surrounding the plant. Consequently, conventional plant load-supporting members are susceptible to tipping when the weight of the plant becomes too great or unbalanced. As another consequence of having to be staked into the soil, conventional load supporting structures cannot be used in situations wherein soft soil leads to unbalance the plant.

Therefore, what is clearly needed is a plant supporting structure for an indeterminate plant that solves the problem mentioned above.

### SUMMARY OF THE INVENTION

The present invention overcomes the problems associated with indeterminate plant support by providing an indeterminate plant support structure. The invention facilitates the support of growing indeterminate plants on hard or impenetrable surfaces. The support structure can be used on ground, planter & buckets, and is collapsible for easy, compact storage of space.

Indeterminate plant support structure includes plant support structure base, telescopic pole, vertical supports, angular supports, connectors, thread feeder, thread & fruit support.

Using plant support structure base, vertical supports and angular supports are coupled with connectors to form a helical shape to grow the indeterminate plant in a helical shape by which height of the plant is converted into circumference of a helical shape.

The present invention also includes a fruit support which is fixed along the angular support in order to distribute the load from the fruit.

The telescopic pole with thread feeder helps to grow the indeterminate plant in vertical position continuously without any limitation in height.

### BRIEF DESCRIPTION OF DRAWINGS

The objects, features and advantages of the present invention will be more readily appreciated as the same becomes better understood from the following detailed description when considered in connection with the accompanying drawing, wherein:

FIG. 1 is a front view of a planter;

FIG. 2 is an isometric view of the planter of FIG. 1;

FIG. 3 is a top view of a plant support structure base;

FIG. 4 is a front view of a plant support structure base of FIG. 3;

FIG. 5 is an isometric view of a plant support structure base of FIG. 3;

FIG. 6 is a front view of a cantilever structure with thread feeder;

FIG. 7 is an isometric view of a cantilever structure with thread feeder of FIG. 6;

FIG. 8 is a front view of a telescopic pole;

FIG. 9 is a front view of a vertical supports;

FIG. 10 is a top view of an angular support;

FIG. 11 is an isometric view of the angular support of FIG. 10;

FIG. 12 is a top view of the connector;

FIG. 13 is a front view of the connector of FIG. 12;

FIG. 14 is an isometric view of the connector of FIG. 13;

FIG. 15 is a front view of a fruit support;

FIG. 16 is an isometric view of the fruit support of FIG. 15;

FIG. 17 is a front view pre-assembly of plant support structure base with planter;

FIG. 18 is a front view assembly of plant support structure base with planter;

FIG. 19 is a front view pre-assembly of a telescopic pole with base and cantilever structure with thread feeder;

FIG. 20 is a front view assembly of a telescopic pole with plant support structure base and cantilever structure with thread feeder;

FIG. 21 is a front view assembly (stage-1) of plant support structure base, telescopic pole and cantilever structure with thread feeder of the present invention;

FIG. 22 is a front view assembly (stage-1) of plant support structure base, telescopic pole and cantilever structure with function of thread feeder;

FIG. 23 is a front view of a small indeterminate plant grown according to the present invention;

FIG. 24 is a front view of an indeterminate plant grown to the maximum height of the telescopic pole of the present invention;

FIG. 25 is a front view pre-assembly (stage-2) of vertical supports and connectors on the base of the present invention;

FIG. 26 is a front view pre-assembly (stage-2) of angular supports coupled with connectors of the present invention;

FIG. 27 is a front view assembly of an indeterminate plant support structure (stage-2) of the present invention;

FIG. 28 is a front view pre-assembly of a fruit support in an indeterminate plant support structure (stage-2) of the present invention;

FIG. 29 is a front view assembly of a fruit support in an indeterminate plant support structure (stage-2) of the present invention;

FIG. 30 is a front view of an indeterminate plant grown on an indeterminate plant support structure (stage-2) of the present invention;

FIG. 31 is a front view pre-assembly (stage-3) of vertical supports and connectors of the present invention;

FIG. 32 is a front view pre-assembly (stage-3) of angular supports coupled with connectors of the present invention;

FIG. 33 is a front view assembly of an indeterminate plant support structure (stage-3) of the present invention;

FIG. 34 is a front view of an indeterminate plant grown on an indeterminate plant support structure (stage-3) of the present invention;

FIG. 35 is a front view pre-assembly (stage-4) of vertical supports and connectors of the present invention;

FIG. 36 is a front view pre-assembly (stage-4) of angular supports coupled with connectors of the present invention;

FIG. 37 is a front view assembly of an indeterminate plant support structure (stage-4) of the present invention;

FIG. 38 is a front view of an indeterminate plant grown on an indeterminate plant support structure (stage-4) of the present invention;

FIG. 39 is a front view assembly of an indeterminate plant support structure (stage-2) on a flat surface of the present invention;

FIG. 40 is a front view of an indeterminate plant grown on an indeterminate plant support structure (stage-2) on a flat surface of the present invention;

FIG. 41 is a front view assembly of an indeterminate plant support structure (stage-4) on a flat surface of the present invention;

FIG. 42 is a front view of an indeterminate plant grown on an indeterminate plant support structure (stage-4) on a flat surface of the present invention.

### DETAILED DESCRIPTION OF THE INVENTION

The present invention overcomes the problems associated with the prior art, by providing an indeterminate plant support structure that is adopted to rest on a substantially planter or flat surface. In the following description, numerous specific details are set forth (e.g., number of vertical supports, angular supports, connectors, etc.) in order to provide a thorough understanding of the invention.

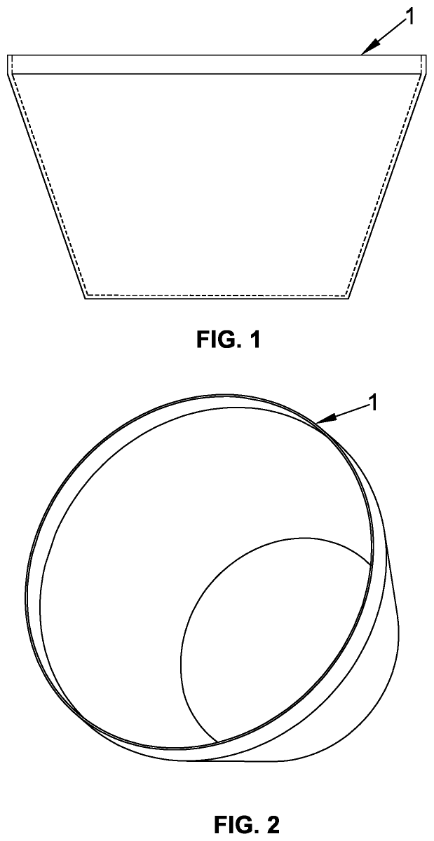

In FIG. 1 shows a front view of a planter 1 or bucket. In this example we have considered a planter 1.

In FIG. 2 shows an isometric view of the planter 1.

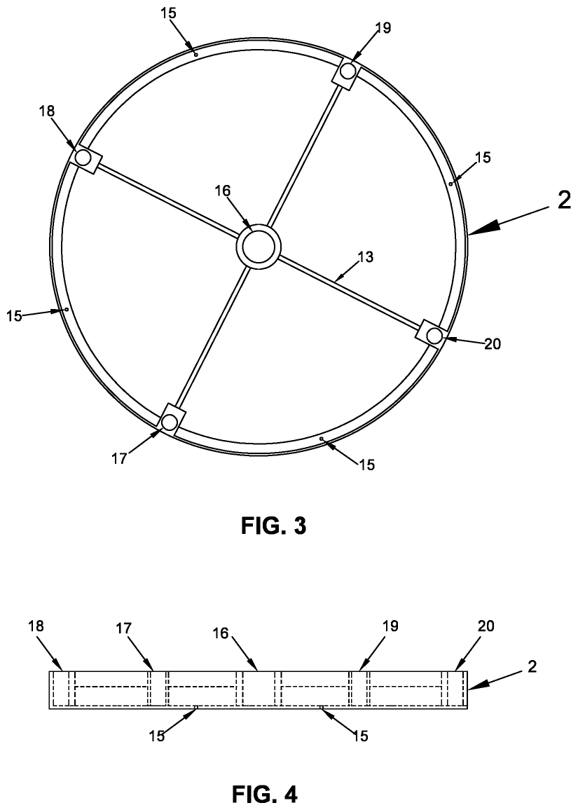

In FIG. 3 shows a top view of a plant support structure base 2. The plant support structure base 2 consists of a central hole 16, which is connected through four bars 13. Holes 17, 18, 19 and 20 are used to hold the vertical supports. Minimum 3 holes and above are required to hold the vertical supports. In this example we have considered 4 numbers of holes. The plant support structure base 2 will hold the vertical supports and telescopic pole 8. There are 4 numbers of holes 15. The purpose of the hole 15 is to screw the plant support structure base 2 with planter 1.

In FIG. 4 shows a front view of the plant support structure base 2.

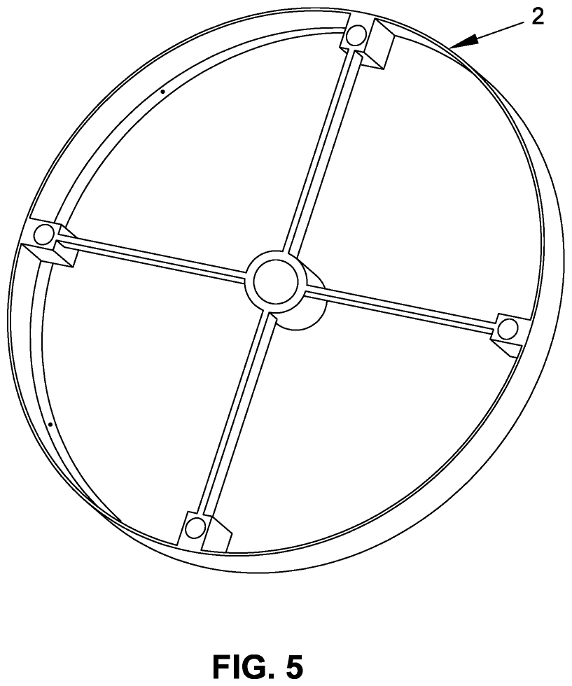

In FIG. 5 shows an isometric view of the plant support structure base 2.

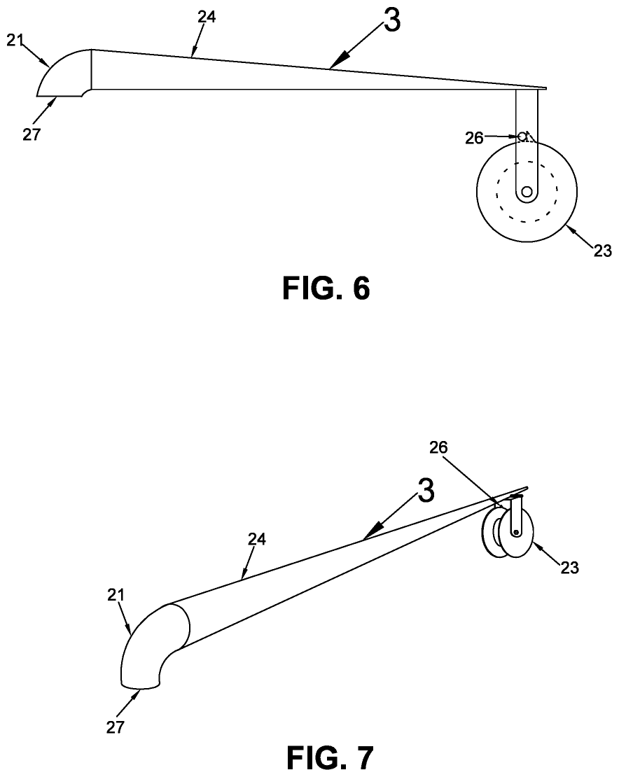

In FIG. 6 shows a front view of a cantilever structure with thread feeder 3, is an extended horizontal cantilever structure 24 to hold thread feeder 23. It consists of an elbow 21 which is used to couple with telescopic pole 4 through hole 27, and the other side of elbow 21 is fixed with the horizontal cone structure. Horizontal structure can be any shape like square, cone, rectangle, circular, etc. In this example we have considered the cone shape.

In FIG. 7 shows an isometric view of the cantilever structure with thread feeder 3.

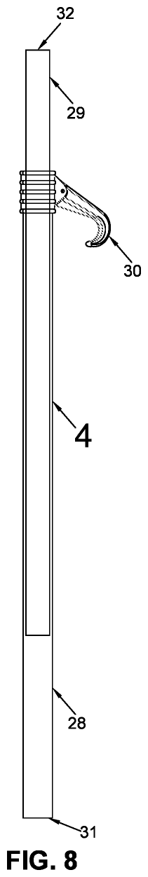

In FIG. 8 shows a front view of telescopic pole 4. Telescopic pole 4 consists of two poles which are circular tube profiles that have one fixed pole 28 and another adjustable pole 29. In fixed pole 28 one end 31 is inserted into plant support structure base 2 and other end has a lock 30 which is used to lock the adjustable pole 29. One end of the adjustable pole 29 is inserted inside the fixed pole 28 and the other end 32 will be above the lock. The purpose of a telescopic pole is to control the vertical height of an indeterminate plant.

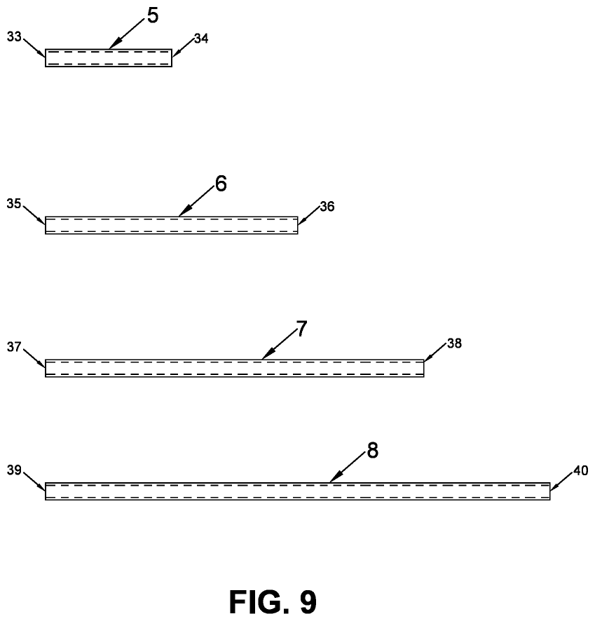

In FIG. 9 shows a front view of vertical supports of different size. Vertical support 5 is an individual piece which can be in any shape like circular, square, rectangular, hexagonal, etc. In this example a circular tube is considered with one end 33 and the other end 34. Length of the vertical support 5 is length of the vertical support 8 divided by 4.

In FIG. 9 vertical support 6 is an individual piece which is a circular tube consisting of one end 35 and the other end 36. Length of the vertical support 6 is length of the vertical support 8 divided by 2.

In FIG. 9 vertical support 7 is an individual piece which is a circular tube consisting of one end 37 and the other end 38. Length of the vertical support 7 is three times the length of the vertical support 8 divided by 4. In FIG. 9 vertical support 8 is an individual piece which is a circular tube consisting of one end 39 and the other end 40.

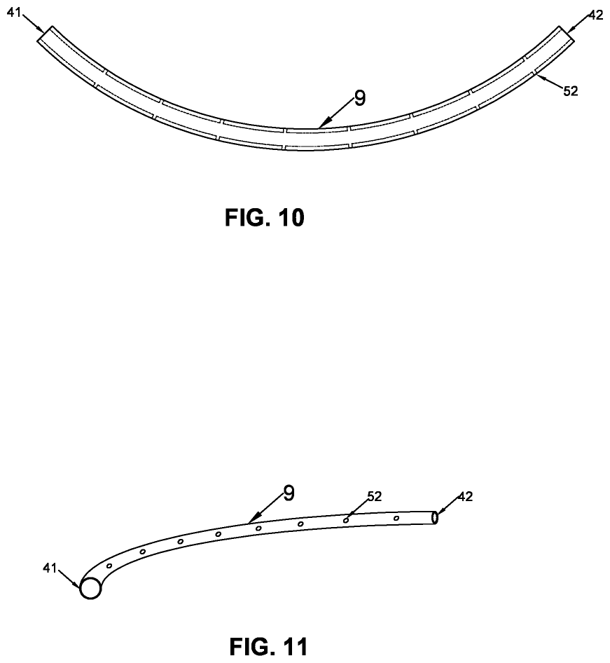

In FIG. 10 shows a top view of the angular support 9, which is a circular tube in a quarter circle in shape, and the tube can be in any shape like circular, square, rectangular, hexagonal, etc. In this example, a circular tube is considered with one end 41 and the other end 42. The length of the tube (L) is 3.14 multiplied by the diameter of the planter (D) divided by 4 (L=(π×D)/4). Tube has multiple holes 52 for inserting fruit support.

In FIG. 11 shows an isometric view of angular support 9 of FIG. 10

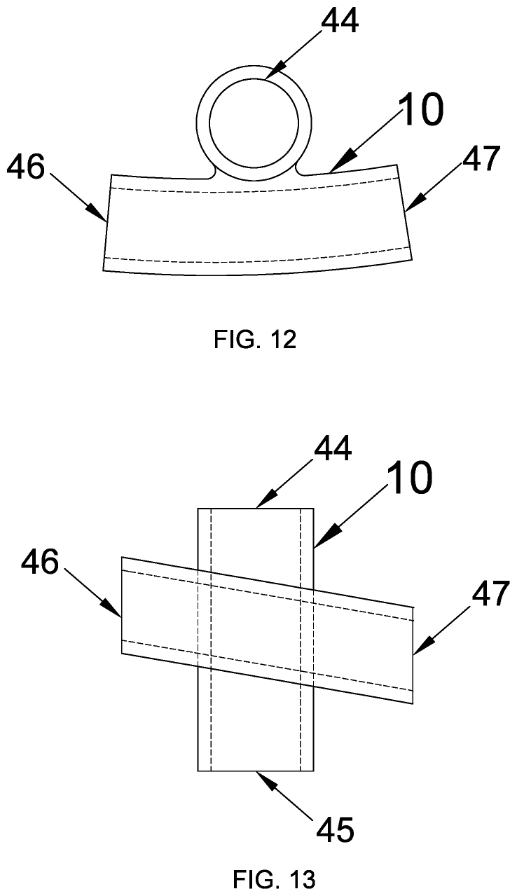

In FIG. 12 shows the top view of connector 10. Connector 10 is an individual piece which is used to couple the vertical supports & angular supports 9. The vertical supports are inserted through hole 44 & hole 45. Angular supports 9 are inserted through hole 46 & hole 47, respectively.

In FIG. 13 shows the front view of connector 10 of FIG. 12

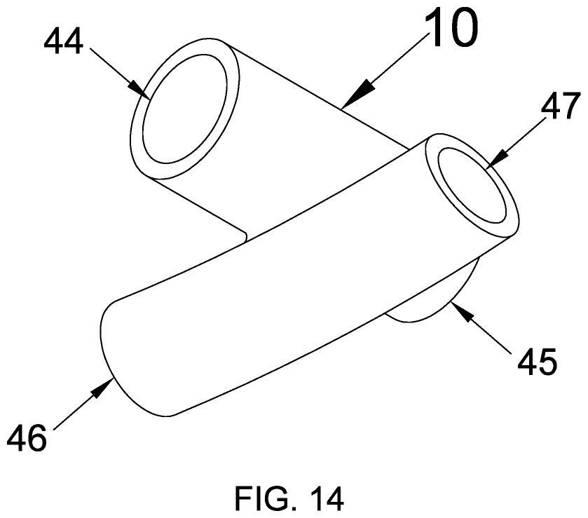

In FIG. 14 shows an isometric view of connector 10 of FIG. 12.

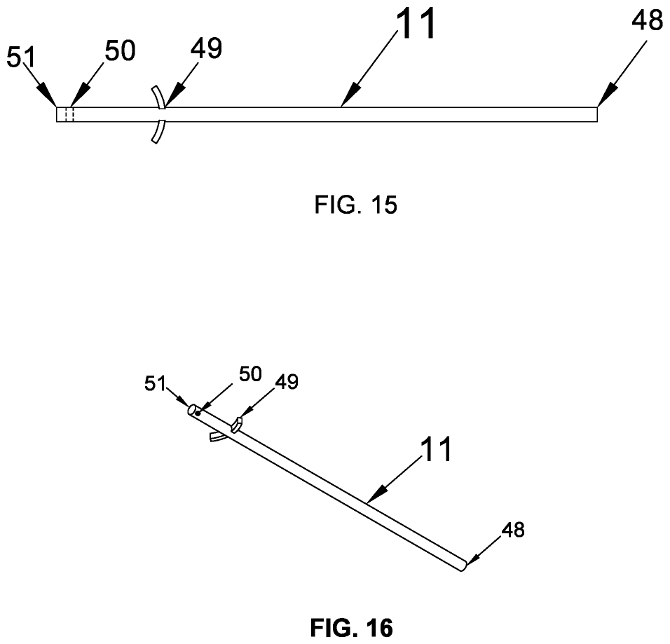

In FIG. 15 shows a front view of fruit support 11. The purpose of fruit support 11 is to hold the fruit. In order to have high yield and to avoid fruit stem breaking, when the fruits gets mature. Fruit support 11 is a rod with one end 48 and the other end 51 with a stopper 49 on it. There is a hole 50 which is used to insert a pin in order to lock the fruit support 11 along with the angular support 9.

In FIG. 16 shows an isometric view of fruit support 11 of FIG. 15.

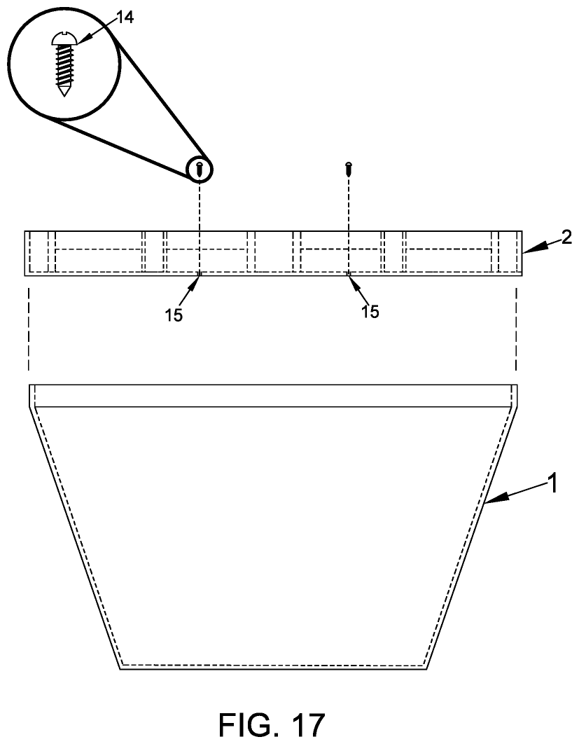

In FIG. 17 shows a front view pre-assembly of plant support structure base 2 with planter 1. The plant support structure base 2 to be mounted above the planter 1. In order to clamp the plant support base 2 with planter 1. A metal screw 14 is fastened along with planter 1 through the hole 15 in the plant support structure base 2. The plant support structure base 2 can also be placed above the flat ground. When the plant support structure base 2 is placed above the ground, a long nail should be used on the hole 15.

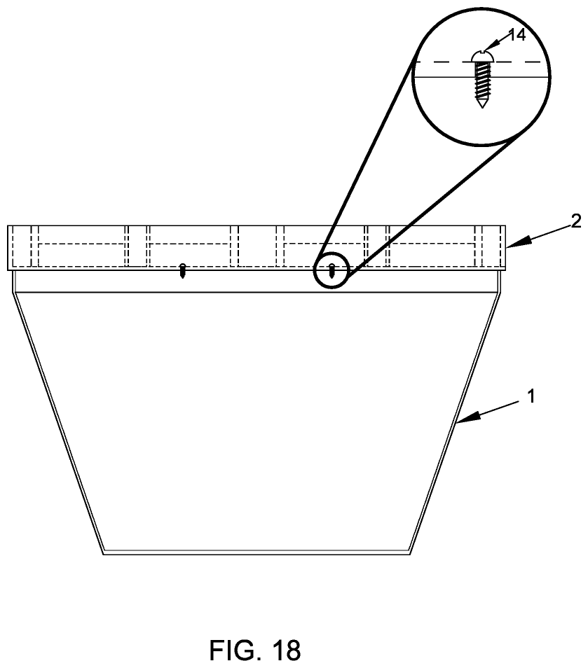

In FIG. 18 shows a front view of plant support structure base 2 assembled with planter 1.

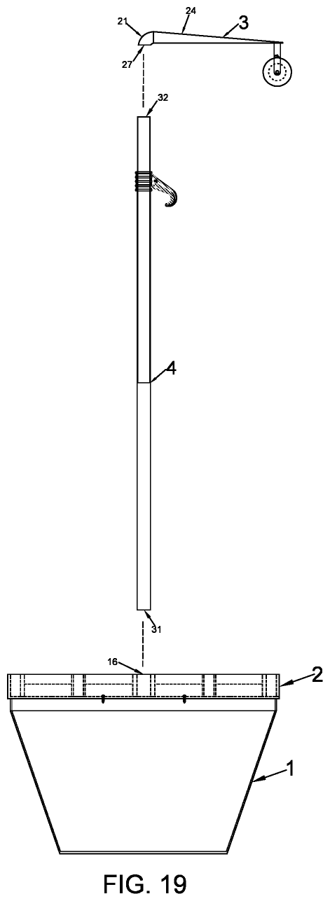

In FIG. 19 shows a front view pre-assembly of plant support structure base 2 with telescopic pole 4 and horizontal cantilever structure with thread feeder 3. The bottom end 31 of the telescopic pole 4 is inserted into the hole 16 of the plant support structure base 2. A growing median is to be used in the planter. Therefore, there is no need to fastening the telescopic pole with the plant support structure base 2. Top end 32 of the telescopic pole 4 to be coupled with the hole 27 of horizontal cantilever structure with thread feeder 3.

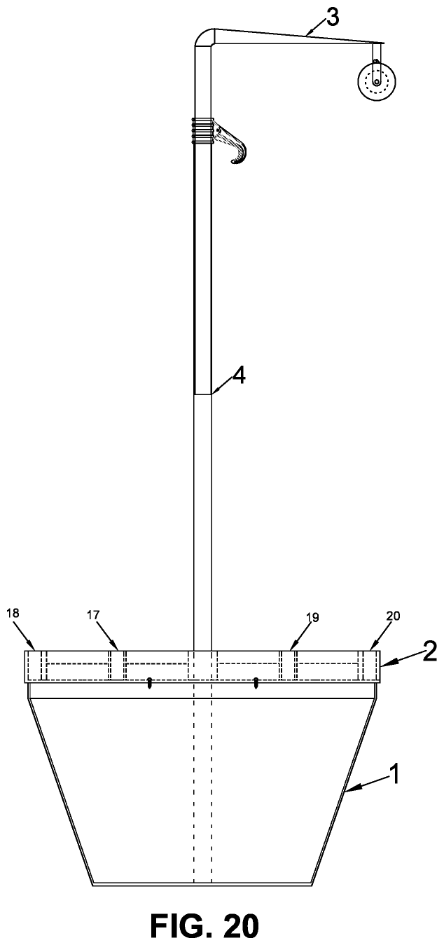

In FIG. 20 shows a front view assembly (stage-1) of plant support structure base 2, telescopic pole 4 and horizontal cantilever structure with thread feeder 3.

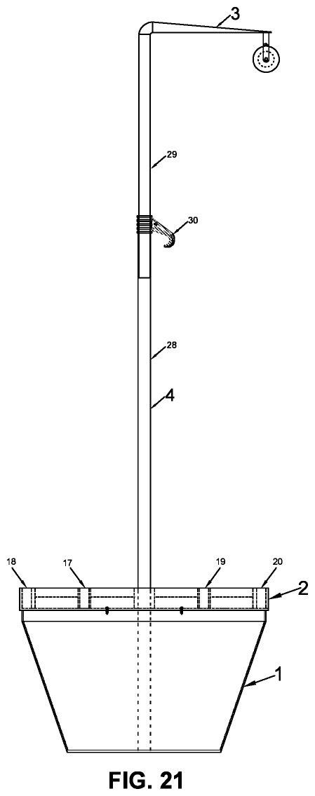

In FIG. 21 shows a front view assembled (stage-1) of plant support structure base 2, telescopic pole 4 and horizontal cantilever structure with thread feeder 3. After coupling the telescopic pole 4. The bottom pole 28 of the telescopic pole 4 will be a fixed pole and the top pole 29 is an adjustable pole. As the plant grows the adjustable pole 29 height can be increased and locked using the lock 30. The adjustable pole 29 can be rotated 360 degrees.

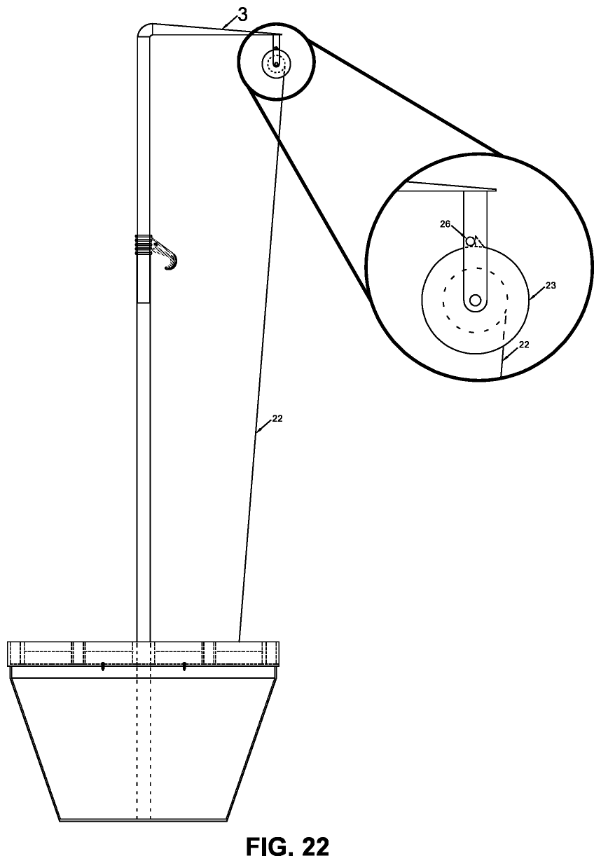

In FIG. 22 shows a front view assembled (stage-1) of plant support structure base 2, telescopic pole 4 and horizontal cantilever structure with thread feeder 3. Thread feeder 23 is used to feed thread in which plant steam is grown along with thread 22. Thread feeding is controlled by the stopper 26. Thread helps the indeterminate plant to hold vertically.

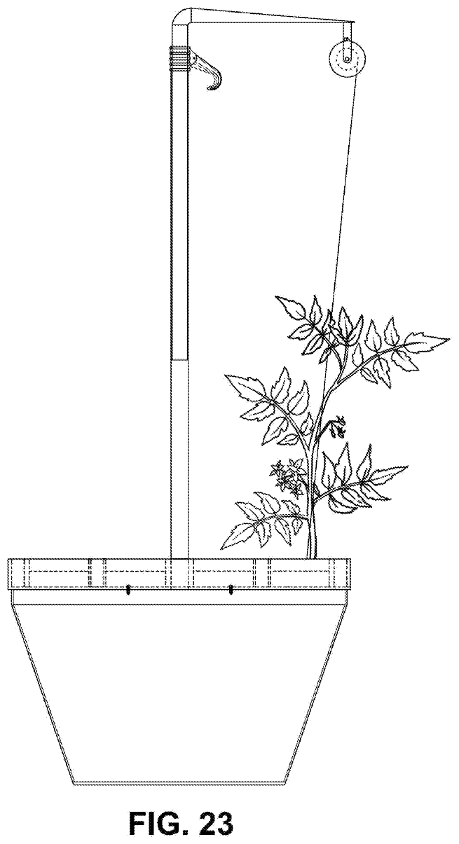

In FIG. 23 shows a front view of small indeterminate plant grown on the present invention.

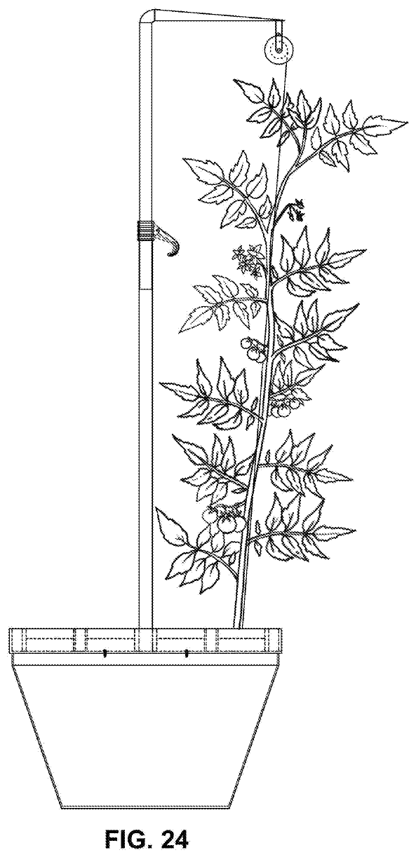

In FIG. 24 show a front view of an indeterminate plant grown to the maximum height of telescopic pole 4 on the present invention.

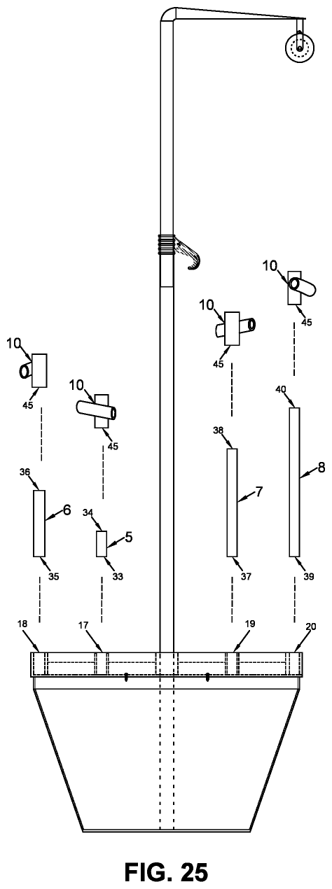

In FIG. 25 once the plant reaches the max height of the telescopic pole 4. Stage 2 assembly of the present invention to be started. For illusion purposes thread and plant have been removed.

In FIG. 25 shows a front view pre-assembly of vertical support with connector 10. Bottom end 33 of vertical support 5 is inserted into the hole 17 of plant support structure base 2, and the top end 34 of the vertical support 5 is inserted inside the bottom hole 45 of the connector 10.

In FIG. 25 shows a front view pre-assembly of vertical support with connectors 10. Bottom end 35 of vertical support 6 is inserted into the hole 18 of plant support structure base 2, and the top end 36 of the vertical support 6 is inserted inside the bottom hole 45 of the connector 10.

In FIG. 25 shows a front view pre-assembly of vertical support with connectors 10. Bottom end 37 of vertical support 7 is inserted into the hole 19 of plant support structure base 2, and the top end 38 of the vertical support 7 is inserted inside the bottom hole 45 of the connector 10.

In FIG. 25 shows a front view pre-assembly of vertical support with connector 10. Bottom end 39 of vertical support 8 is inserted into the hole 20 of plant support structure base 2, and the top end 40 of the vertical support 8 is inserted inside the bottom hole 45 of the connector 10.

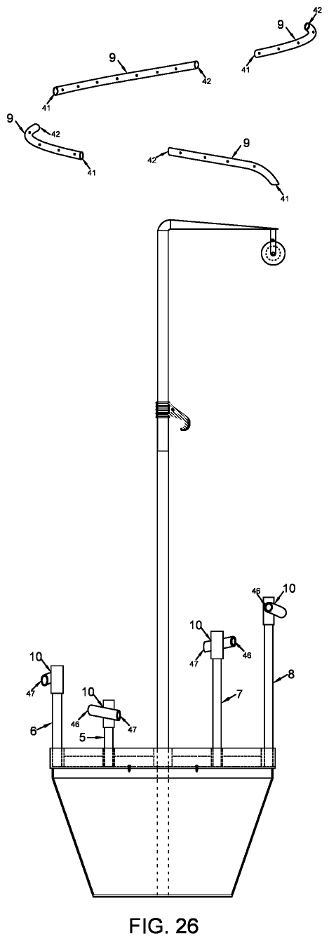

In FIG. 26 shows an assembled front view of vertical support 5, 6, 7 and 8 along with connector 10. One end 41 of angular support 9 is inserted into the hole 46 of the connector 10 and the other side 42 of angular support 9 is inserted into the hole 47 of the connector 10, which forms a helical shape. For illusion purposes thread and plant have been removed.

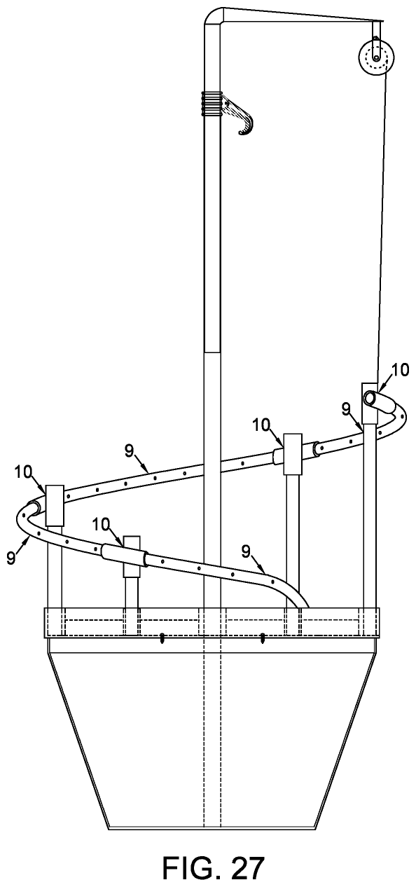

In FIG. 27 shows a front view assembly (stage-2) of indeterminate plant support structure of present invention. For illusion purposes, the plant has been removed.

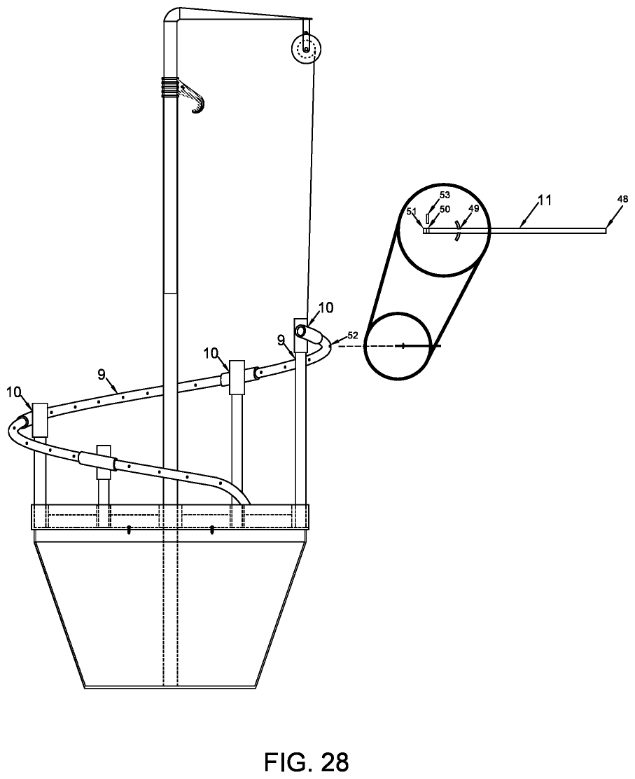

In FIG. 28 shows a front view pre-assembly of fruit support 11 in indeterminate plant support structure (Stage-2) of the present invention. The fruit support 11 is inserted in the hole 52 of the angular support 9. In fruit support 11, there is a stopper 49 which ensures the fruit support 11 is stopped at a particular distance and ensures the pin 53 is inserted into the hole 50 properly. The purpose of fruit support 11 is to distribute the load of the fruit on the fruit support 11. Fruit support 11 avoids the breaking of fruit steam when the fruit gets mature. For illusion purposes, the plant has been removed.

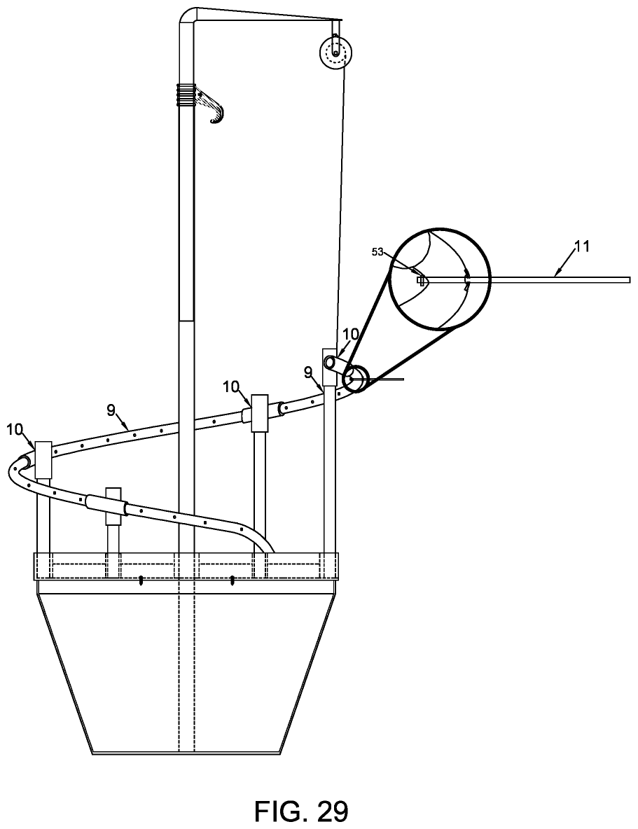

In FIG. 29 shows a front view assembly of fruit support in indeterminate plant support (Stage-2) of the present invention. For illusion purposes, the plant has been removed.

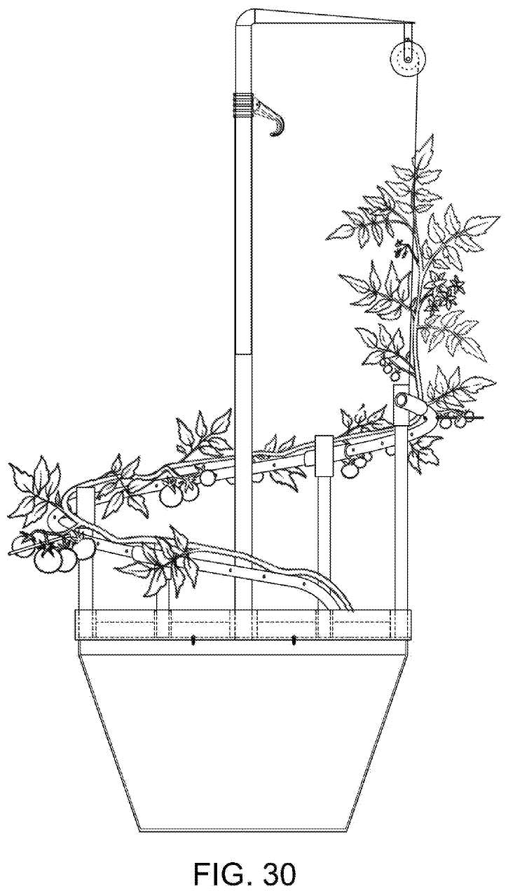

In FIG. 30 shows a front view of an indeterminate plant grown on an indeterminate plant support structure (Stage-2) of the present invention. The plant stem is placed above the angular support 9 and tied along with the angular support 9 to form a helical shape. The height of the plant is converted into the circumference of a helical shape. By doing the process, the height of the plant is reduced and the telescopic pole height is also reduced. Fruit support is used wherever it's required.

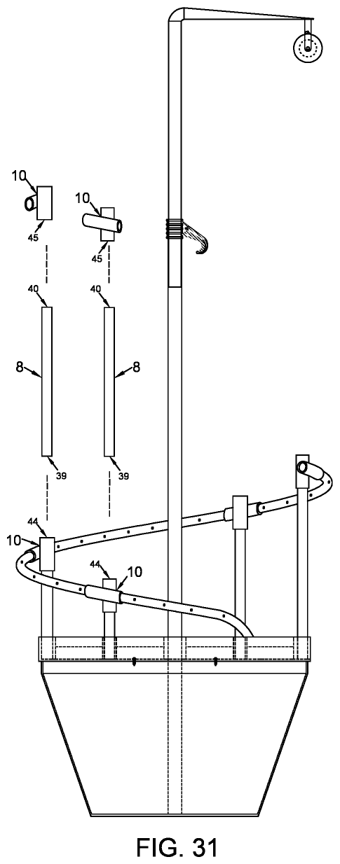

In FIG. 31 shows a front view pre-assembly (stage-3) of indeterminate plant support structure. Once the plant reaches the max height of the telescopic pole 4. Stage 3 assembly of the present invention to be started. Bottom end 39 of vertical supports 8 is inserted into the hole 44 of the connectors 10, and the top end 40 of the vertical supports 8 is inserted inside the bottom hole 45 of the connectors 10. For illusion purposes thread and plant have been removed.

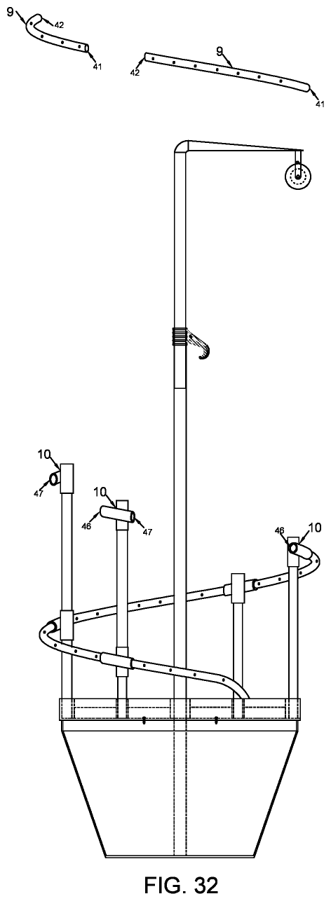

In FIG. 32 shows an assembled front view of vertical supports 8 along with connectors 10. One end 41 of the angular supports 9 is inserted into the hole 46 of the connectors 10 and the other end 42 of the angular supports 9 is inserted into the hole 47 of the connectors 10. For illusion purposes thread and plant have been removed.

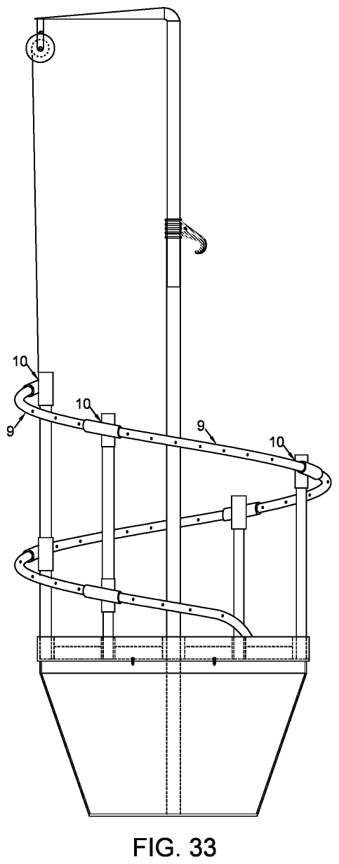

In FIG. 33 shows a front view assembly (stage-3) of indeterminate plant support structure of present invention. For illusion purposes, the plant has been removed.

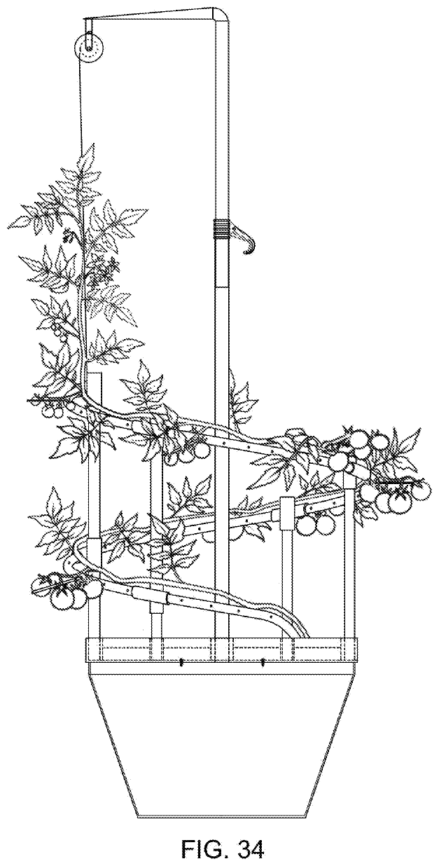

In FIG. 34 shows a front view of an indeterminate plant grown on an indeterminate plant support structure (stage-3) of present invention. The plant stem is placed above the angular support 9 and tied up along with the angular support 9 to form a helical shape. Fruit support is used wherever it's required.

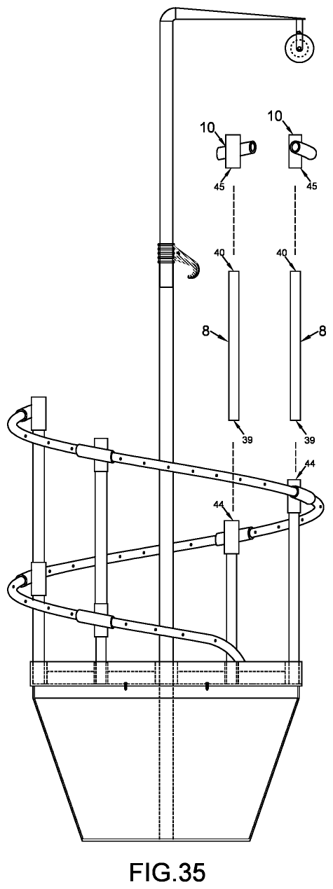

In FIG. 35 shows a front view pre-assembly (stage-4) of indeterminate plant support structure. Once the plant reaches the max height of the telescopic pole 4. Stage 4 assembly of the present invention to be started. Bottom end 39 of vertical supports 8 is inserted into the hole 44 of the connectors 10, and the top end 40 of the vertical supports 8 is inserted inside the bottom hole 45 of the connectors 10. For illusion purposes thread and plant have been removed.

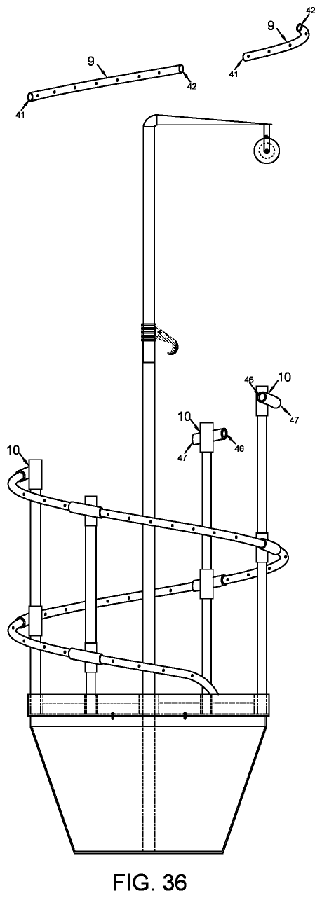

In FIG. 36 shows an assembled front view of vertical support 8 along with connectors 10. One end 41 of angular supports 9 is inserted into the hole 46 of the connectors 10 and the other end 42 of angular supports 9 is inserted into the hole 47 of the connectors 10. For illusion purposes thread and plant have been removed.

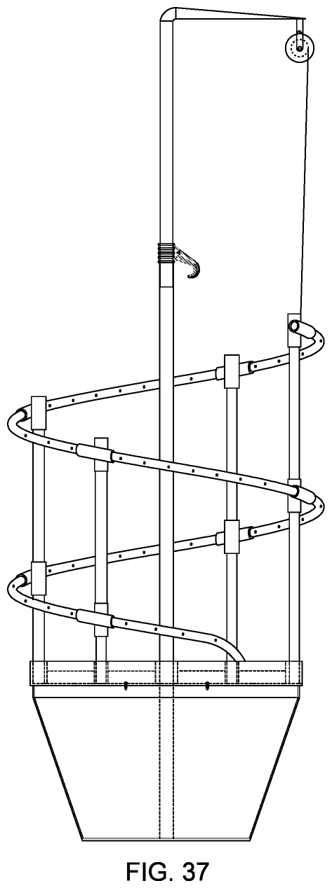

In FIG. 37 shows a front view assembly (stage-4) of indeterminate plant support structure of present invention. For illusion purposes, the plant has been removed.

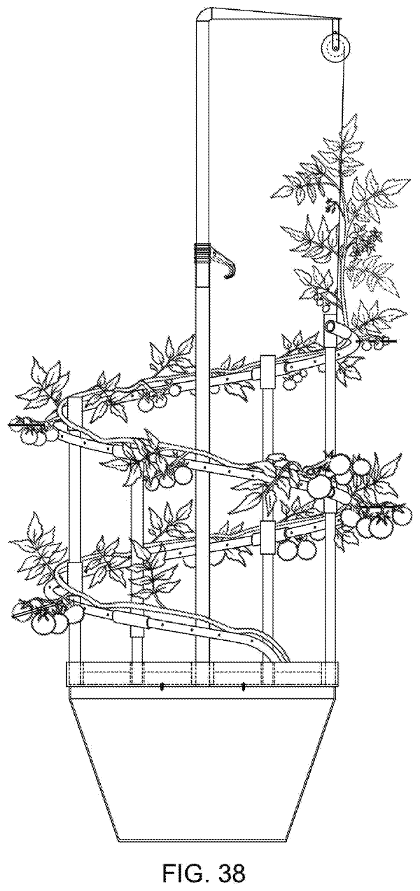

In FIG. 38 shows a front view of an indeterminate plant grown on an indeterminate plant support structure (stage-4) of present invention. The plant stem is placed above the angular support 9 and tied up along with the angular support 9 to form a helical shape. Fruit support is used wherever it's required. As the plant grows the number of stages also increases until the plant dies.

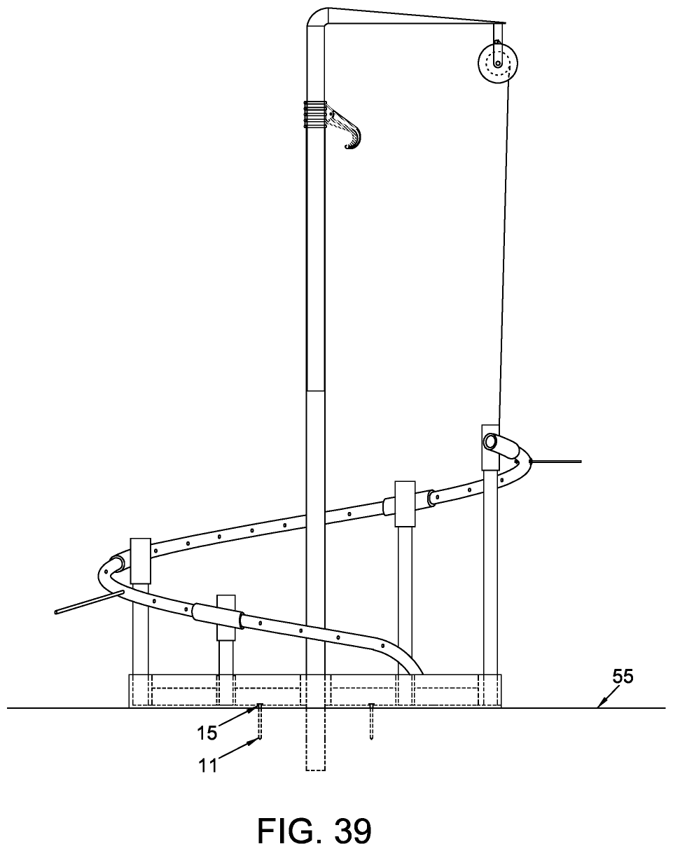

FIG. 39 shows a front view assembly of an indeterminate plant support structure (stage-2) on a flat surface of the present invention. A long nail 11 is used on the hole 15 to join the plant support structure base 2 with ground 55.

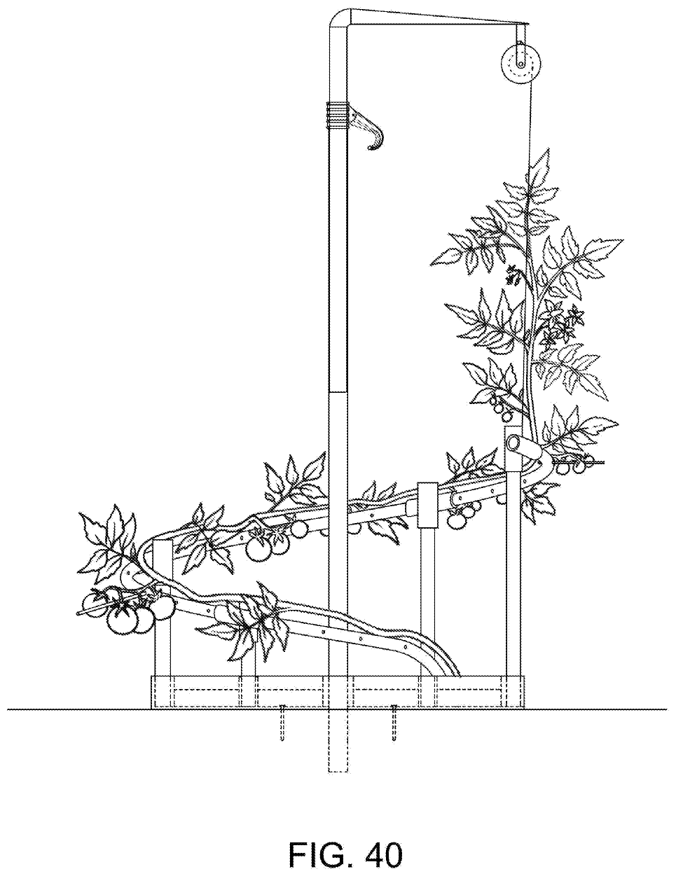

FIG. 40 shows a front view of an indeterminate plant grown on an indeterminate plant support structure (stage-2) on a flat surface of the present invention. The plant stem is placed above the angular support 9 and tied up along with the angular support 9 to form a helical shape. Fruit support is used wherever it's required.

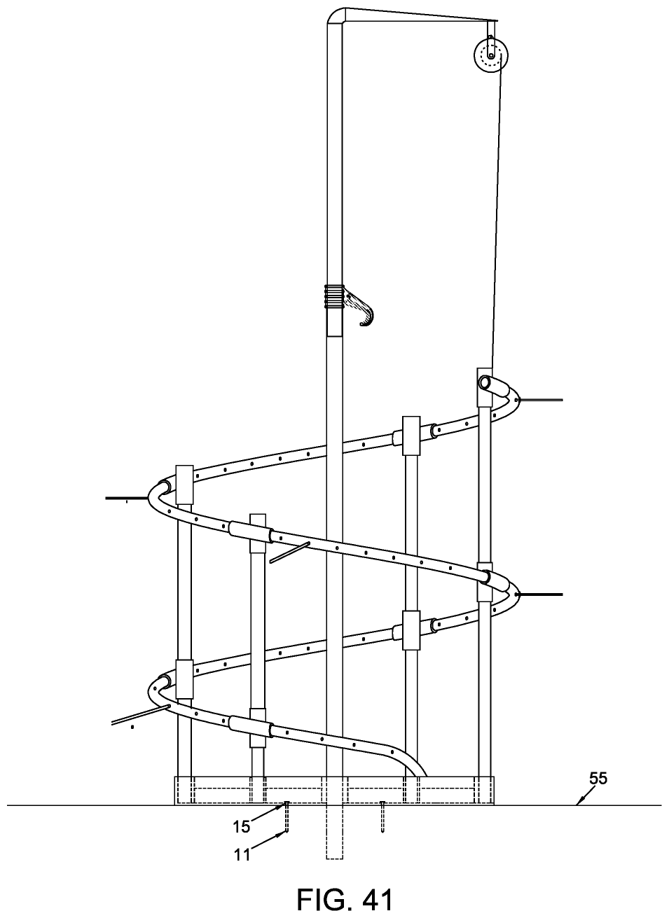

FIG. 41 shows a front view assembly view of an indeterminate plant support structure (stage-4) on a flat surface of the present invention. A long nail 11 is used on the hole 15 to join the plant support structure base 2 with ground 55.

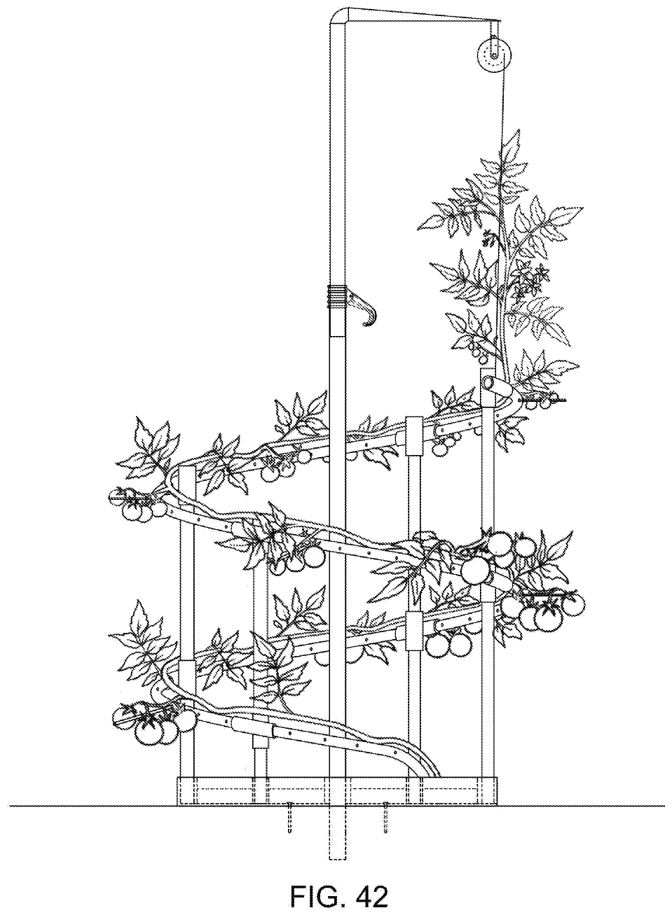

FIG. 42 shows a front view of an indeterminate plant grown on an indeterminate plant support structure (stage-4) on a flat surface of the present invention. The plant stem is placed above the angular support 9 and tied up along with the angular support 9 to form a helical shape. Fruit support is used wherever it's required. As the plant grows the number of stages also increases until the plant dies.

I claims:

1. A indeterminate plant support structure comprising:
a telescopic pole, cantilever structure for thread feeder and thread to grow the plant vertically,
plant support structure base, vertical supports, angular supports, and connectors to form helical shape on which the plant load is transferred,
fruit support is attached to the angular support.
The indeterminate plant support structure of claim, 1 wherein said indeterminate plant is grown vertically by using a thread, thread feeder and telescopic pole which is coupled with a cantilever structure.
The indeterminate plant support structure of claim, 2 wherein said plant support base is attached to three or more vertical supports and angular supports are coupled with vertical supports by connectors to form a helical shape.
The indeterminate plant support structure of claim, 2 wherein said helical shape is formed at multiple stages by which the height of the plant is converted into a circumference of a helical shape.
The indeterminate plant support structure of claim, 2 wherein said indeterminate plant stem is placed above the angular support and load on the indeterminate plant is distributed to the angular support.
The indeterminate plant support structure of claim, 3 wherein said fruit supports are inserted in an angular support wherever required to distribute the fruit load.
